(19) United States
(12) Patent Application Publication
(10) Pub. No.: US 2001/0037235 A1
(43) Pub. Date: Nov. 1, 2001

(54) Method for rating products and developing a dialogue between consumers and businesses

(76) Inventor: Adam Fishman, Nashua, NH (US)

Correspondence Address: DEVINE, MILLIMET & BRANCH, P.A., 111 AMHERST STREET, BOX 719, MANCHESTER, NH, 03105, US

(21) Appl. No.: 09/846,625

(22) Filed: May 1, 2001

Related U.S. Application Data
(60) Provisional application No. 60/201,572, filed on May 1, 2000.

(51) Int. Cl. G06F 17/60

(52) U.S. Cl. 705/12

(57) ABSTRACT

The present invention is a method for initiating communication between at least one seller of goods and/or services and at least one consumer through an electronic agent. The first step for the method is providing the electronic agent. The second step is making the electronic agent accessible to the consumers. The third step to the method is recording a access method for prospectively communicating with consumers who access the electronic agent. The final step is providing at least one seller with access to the access method through the electronic agent to communicate with consumers who accessed the electronic agent.

The instant application claims the benefit of U.S. Provisional Application Ser. No. 60/201,572 filed on May 1, 2000.

### FIELD OF THE INVENTION

This invention is in the field of market testing and polling. More specifically, this invention is in the field of market polling through the global computer network Even more specifically, this invention is in the field of market polling through the global computer network as a prelude to establishing an open dialogue between providers of goods and services and their interested consumers and prospective consumers.

### BACKGROUND OF THE INVENTION

Over the last ten years, the global computer network has revolutionized the manner in which information is transmitted. Through thousands, if not millions, of Web sites from around the globe, information is published and shared. As amazing as the change has been, there is room for improved information transmission.

More specifically, the global computer network has created an untapped potential for opening up a dialogue between consumers, hereinafter understood to mean both active and potential consumers, and providers of goods and services, hereinafter referred to as businesses, in a manner that to date has been unavailable. There is an apparent interest for a dialogue between businesses and consumers from both parties. That apparent interest is evident when looking at communication efforts in the prior art. One communication effort between consumers and businesses in the prior art is market polling.

One method of market polling is blind telephone calls. Sellers of goods and services hire agencies to call random listings of numbers to ask consumers prepared questions concerning goods and services provided by the seller and other products on the market. This method of communication is flawed for several reasons. First, it disturbs many of the consumers by invading their homes when, most likely, they are not interested in answering questions. Second, the prepared questions are normally geared toward rigid responses and do not give the consumers an opportunity to express themselves completely. Finally, there is never an opportunity for either party to follow up the telephone poll with additional questions or answers at a later date, after the parties have had an opportunity to ponder the questions and answers further.

Another problem with blind telephone calls is they fail to take into account the interests of the consumers being called. The recipients of the phone calls may have fanatic interest in the subject of the poll or may be completely different and the input provided by the recipients is valued the same way. A better system of gathering input from consumers would allow businesses to collect input only from those consumers interested in their type of product.

Another method of communication between businesses and consumers is through consumers taking the initiative to mail, electronically mail, or telephonically deliver unsolicited opinions to the businesses. This method of dialogue is also rife with problems. One problem is that, for larger businesses, the mailings and comments arrive in large volume without any efficient means of organizing the opinions. The sheer complexity of dealing with the opinions prompts many businesses to respond with little more than a form letter. Also, because the opining consumers have not consulted with the businesses in advance, vital information is often omitted from the opinions. The result is yet another unsatisfactory effort at dialogue.

### SUMMARY OF THE INVENTION

The present invention results from the realization that an interactive Web site for unobtrusively soliciting consumer opinions and initiating an organized, civil, and flexible dialogue between businesses and consumers will result in businesses meeting consumer needs more effectively and a higher level of respect between businesses and consumers.

It is therefore an object of this invention to improve businesses' goods and services by improving the dialogue between consumers and businesses.

It is a further object of this invention to organize consumer communications with businesses.

It is a further object of this invention to allow consumers to provide their opinions at times that are convenient for them.

It is a further object of this invention to allow businesses to gather communications from those consumers who have an interest in their type of product.

It is a further object of this invention to allow continuing dialogue between businesses and consumers after one party has initiated communication, while protecting the privacy of the consumer.

### BRIEF DESCRIPTION OF THE DRAWINGS

The novel features believed characteristic of the invention are set forth in the claims. The invention itself however, as well as other features and advantages thereof, will be best understood by reference to the description which follows, read in conjunction with the accompanying drawings, wherein:

FIG. 1 shows a flow diagram of one embodiment of the present invention.

FIG. 2 shows a flow diagram of another embodiment of the present invention.

FIG. 3 shows a one-line diagram of one embodiment of the present invention.

FIG. 4 shows a one-line diagram of another embodiment of the present invention.

FIG. 5 shows a flow diagram of another embodiment of the present invention.

### DETAILED DESCRIPTION OF THE INVENTION

The essence of this invention is first a website on a global computer network at which individuals (i) may vote to rate goods and services in various categories and (ii) may review the resulting compilation from the aggregate votes. Such on-line polling may not be new and novel. However, PickCity proposes to go a step further. It will allow the business provider of a particular service or product that is the subject of a polling vote to communicate through the electronic agent with all the individuals who either voted in the category that includes their service or product or who are reviewing the voting results. Herein lies the inventive element of the website. The means of communication for reaching the individuals is controlled by the website. This control will allow individuals to have a level of privacy that would be unavailable if the individuals were to electronically contact businesses directly.

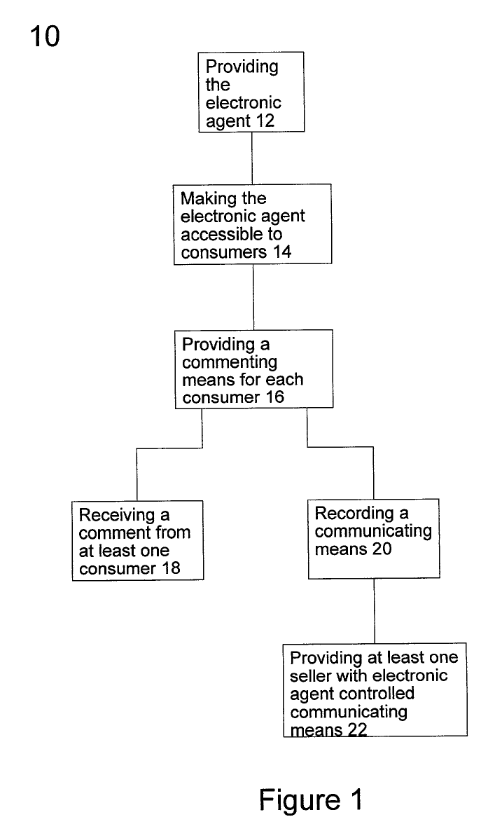

Therefore, this invention is a method 10, shown in FIG. 1, for initiating communication between at least one seller of goods and/or services and at least one consumer through an electronic agent. The first step to this method 10 is providing 12 the electronic agent that contains at least one opportunity for commenting on a subject. The second step is making the electronic agent accessible 14 to the consumers. The next step to the method 10 is providing 16 a commenting means for each of the consumers to register a comment in the electronic agent. The next step is receiving a comment 18 from at least one commenting consumer. The next step to the inventive method 10 is recording 20 a communicating means for prospectively communicating with the consumers who access the electronic agent. Finally, the last step is providing 22 at least one seller with electronic agent controlled access to the communicating means to communicate with consumers who accessed the electronic agent.

The inventive method 10 has a number of narrower embodiments. One narrower embodiment involves making the electronic agent available over a global computer network. This embodiment is narrower because it is conceivable the electronic agent could be made available across a global telephonic network through cellular phones, or through other networks that do not require the use of a computer for individuals to supply comments.

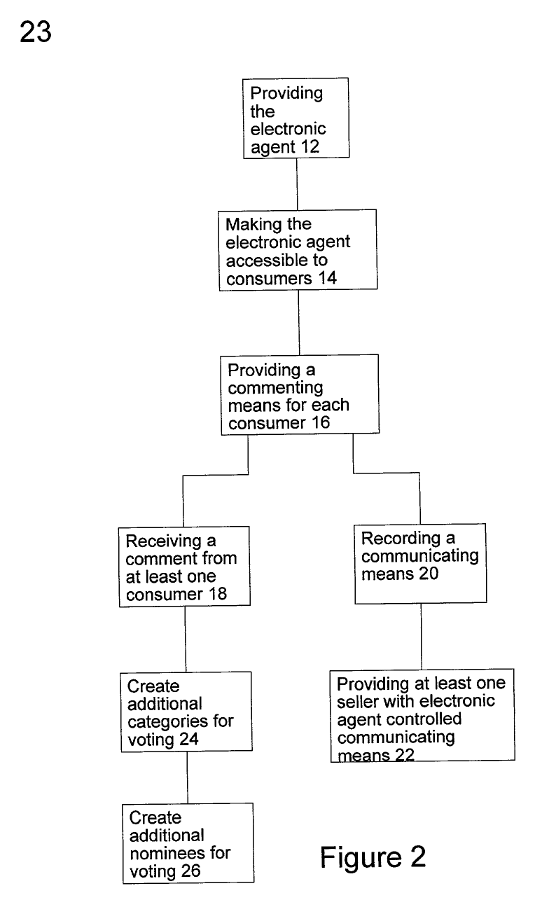

Another narrower embodiment 23, shown in FIG. 2, involves making the opportunity to comment based on one or more voting categories. The consumers, who access the website, can then comment on the nominees in a voting category, vote on the nominees, or submit another type of response. Allowing the consumers to create additional categories 24 for voting could further narrow this embodiment. Similarly, allowing consumers to create additional nominees 26 in categories for voting could further narrow this embodiment.

The invention is also an electronic agent apparatus 30, shown in FIG. 3, for initiating communication between at least one seller 32 of goods and/or services and at least one consumer 34. The apparatus 30 contains a commenting section 36. Further contained is an access means 38 to the agent 30 over a global computer network. The apparatus 30 also includes a commenting means 40 for at least one commenting consumer 34 to register a comment. The apparatus 30 also has a communication collection means 42 for receiving and storing a means of communicating with at least one consumer 34 who uses the access means 38. Finally, the agent 30 includes a communication access means 44 for allowing businesses 32 to communicate with consumers 34 who use the access means 38 wherein the communications access means 44 is only operable through the electronic agent 30.

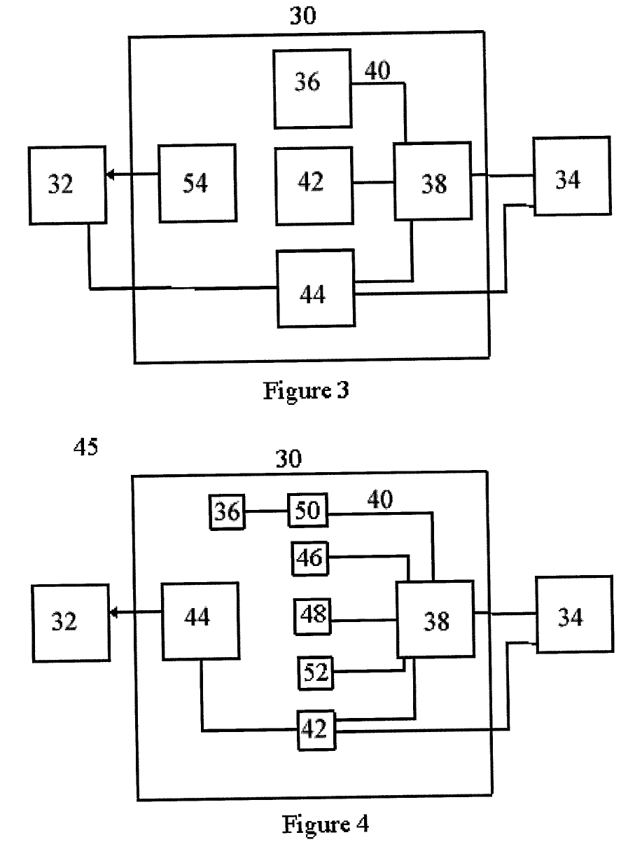

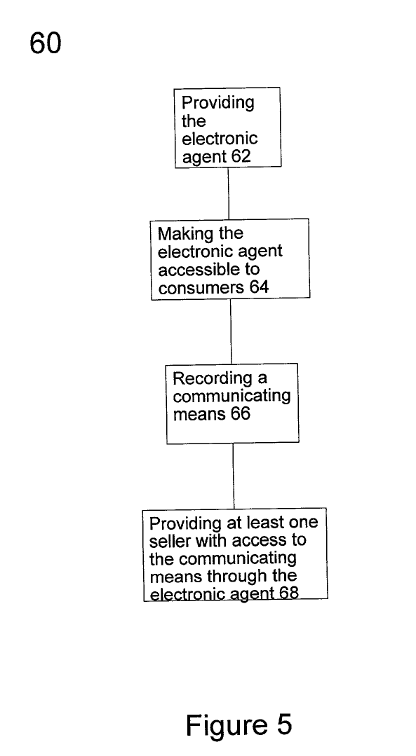

A narrower embodiment, shown in FIG. 4, involves configuring the commenting section 36 for market polling 45, thereby allowing consumers 34 to register votes in the electronic agent 30. The electronic agent apparatus 30 could further include a voting category creation means 46 for allowing consumers 34 to create categories for voting in the market poll. The electronic agent apparatus 30 could further include a voting nominees creation means 48 for allowing consumers 34 to create nominees for voting in the market poll. Another narrower embodiment could involve permitting consumers 34 to display results of the voting in the market poll. This embodiment could be further narrowed by including an information recordation means 50 for recording personal characteristic information on voting consumers (i.e. gender, age, etc.) and a compilation means 52 for allowing a consumer 34 viewing the results section to compile a vote total according to recorded demographics on voting consumers 34.

The electronic agent apparatus 30, in a narrower embodiment, could also include an electronic link 54 between at least one business 32 named in one of the voting categories or as one of the voting nominees and at least one electronic address for the businesses 32 on a global computer network.

The invention could also be described as a method 60 for initiating communication between at least one seller 32 of goods and/or services and at least one consumer 34 through an electronic agent 30. The first two steps for the method 60 would be providing 62 the electronic agent 30 and making the electronic agent 30 accessible 64 to the consumers 34. The third step to the method 60 is recording 66 a communicating means for prospectively communicating with consumers 34 who access the electronic agent 30. The final step is providing 68 at least one seller 32 with access to the communicating means through the electronic agent to communicate with consumers 34 who have accessed the electronic agent 30.

One of the real benefits of this invention is the consumers' ability to make themselves accessible to sellers 32 of goods and services, in which they have an interest. Using the market polling website embodiment as an example, if there are two hundred different voting categories for which to vote and a consumer 34 votes in five categories, that consumer 34 has indicated an interest in the topics covered by those five categories. A business 32 that sells in or has an interest in any of those five categories can contact the consumer 34, through the electronic agent 30, to ask questions about their interest, voting decision, future marketing plans, or just to provide information. The business 32 never holds any address or specific consumer information or other contact means, but must use the electronic agent 30 to establish all contact. This arrangement provides a level of anonymity for the consumer 34 and allows the consumer 34 to stop all future contacts simply by changing or removing their contact information from their registration on the website. In this regard, the invention operates as a protective intermediary between businesses 32 and consumers 34.

In another embodiment, the seller 32 of a good or product that is rated in a specific category can send an email to each individual who voted for any product rated in that category. For example, the provider of a product that is voted number two in a specific category can send an email to each individual who voted for that product. As a further example, the provider of the product can also send a different email to each individual who voted for the product that is rated number one in the category or who voted for any product in the category.

We claim:

1. A method for initiating communication between at least one seller of goods and/or services and at least one consumer through an electronic agent comprising:
providing the electronic agent that contains at least one opportunity for commenting on a subject;
making the electronic agent accessible to the consumers;
providing a commenting means for each of the consumers to register a comment in the electronic agent;
receiving a comment from at least one commenting consumer;
recording a communicating means for prospectively communicating with the consumers who access the electronic agent; and
providing at least one seller with electronic agent controlled access to the communicating means to communicate with consumers who accessed the electronic agent.

2. The method of claim 1 wherein the opportunity to comment is based on at least one voting category whereby the comments can range from voting for at least one category nominee to opinions on the voting nominees.

3. The method of claim 1 wherein the electronic agent is made available over a global computer network.

4. The method of claim 2 wherein the consumers can create additional categories for voting.

5. The method of claim 2 wherein the consumers can create additional nominees in a category for voting.

6. An electronic agent apparatus for initiating communication between at least one seller of goods and/or services and at least one consumer comprising:
a commenting section within the electronic agent;
an access means to the agent over a global computer network;
a commenting means for at least one commenting consumer to register a comment;
a communication collection means for receiving and storing a method of communicating with at least one consumer who uses the access means; and
a communication access means for allowing businesses to communicate with consumers who use the access means wherein the communications access means is only operable through the electronic agent.

7. The apparatus of claim 6 wherein the commenting section is configured for market polling.

8. The electronic agent apparatus of claim 7 further comprising a voting category creation means for allowing consumers to create voting categories.

9. The electronic agent apparatus of claim 7 further comprising a voting nominees creation means for allowing consumers to create voting nominees.

10. The electronic agent apparatus of claim 6 further comprising an electronic link between at least one business named in one of the voting categories or as one of the voting nominees and at least one electronic address for the businesses on a global computer network.

11. The electronic agent apparatus of claim 7 further comprising a results section for displaying results of the market poll.

12. The electronic agent apparatus of claim 11 further comprising: an information recordation means for recording information on voting consumers; and a compilation means for allowing a person viewing the results section to compile a vote total according to recorded demographics on voting consumers.

13. A method for initiating communication between at least one seller of goods and/or services and at least one consumer through an electronic agent comprising:
providing the electronic agent;
making the electronic agent accessible to the consumers;
recording a communicating means for prospectively communicating with consumers who access the electronic agent; and
providing at least one seller with access, controlled by the electronic agent, to the communicating means to communicate with consumers who accessed the electronic agent.
